(19) United States
(12) Patent Application Publication
(10) Pub. No.: US 2026/0203675 A1
(43) Pub. Date: Jul. 16, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Tomonari TAKAHASHI, Kanagawa (JP); Ryosuke HIGASHIKATA, Kanagawa (JP); Atsushi OGIHARA, Kanagawa (JP); Yasuyuki TANAKA, Kanagawa (JP)

(73) Assignee: FUJIFILM Business Innovation Corp., Tokyo (JP)

(21) Appl. No.: 19/535,283

(22) Filed: Feb. 10, 2026

Related U.S. Application Data
(63) Continuation of application No. PCT/JP2024/025238, filed on Jul. 12, 2024.

(30) Foreign Application Priority Data
Nov. 17, 2023 (JP) 2023-195967

(51) Int. Cl. G06Q 10/00

(52) U.S. Cl. CPC G06Q 10/00

(57) ABSTRACT

An information processing system includes a processor configured to hierarchically display, when a feature represented by three-dimensional model data and linked with product manufacturing information is assessed by an overall inspection result derived from multiple individual inspection results for the feature, the multiple individual inspection results, which indicate whether corresponding multiple measured values of the feature satisfy a preset allowable condition represented by the product manufacturing information, and the overall inspection result for the feature derived from the individual inspection results.

### CROSS-REFERENCE TO RELATED APPLICATIONS

This is a continuation of International Application No. PCT/JP2024/025238 filed Jul. 12, 2024, and claims priority from Japanese Patent Application No. 2023-195967 filed Nov. 17, 2023.

### BACKGROUND

### (i) Technical Field

The present disclosure relates to an information processing system and a non-transitory computer readable medium.

### (ii) Related Art

Japanese U.S. Pat. No. 6,735,367 discloses a shaping mold correction method including: a product designing step of designing a product model, which includes information on a three-dimensional shape and design values of a product, on a product coordinate system, which is a preset three-dimensional coordinate system; a measuring step of measuring positions of multiple measuring points on a trial product on a measurement coordinate system, which is a preset three-dimensional coordinate system; a deviation information calculating step of calculating amounts of deviation between values of the measuring points measured in the measuring step and the design values of points on the product model corresponding to the measuring points; and a display step of displaying the amounts of deviation and a drawing which illustrates the shape of the product of the product model on a display.

### SUMMARY

With the use of three-dimensional model (hereinafter may also be simply called 3D model) data appended with product manufacturing information, a feature of a product linked with product manufacturing information may be assessed by an overall inspection result derived from individual inspection results for this feature. In such a case, if the overall inspection result for this feature is only displayed, a user is unable to understand the outcome of the individual inspection results. That is, if a certain feature is determined to be a fail by the overall inspection result, it is not certain whether this feature has failed because most of the individual inspection results indicate a fail or this feature has failed although only some of the inspection results indicate a fail. Both of the individual inspection results and the overall inspection result may be displayed together, but if they are displayed on the same hierarchical level, the display content becomes complicated as the number of individual inspection results is increased.

Aspects of non-limiting embodiments of the present disclosure relate to an information processing system and a non-transitory computer readable medium in which, when a feature represented by 3D model data and linked with product manufacturing information is assessed by an overall inspection result derived from individual inspection results for this feature, both of the individual inspection results, which indicate whether multiple measured values of the feature satisfy a preset allowable condition represented by the product manufacturing information, and the overall inspection result derived from the individual inspection results can be identified without displaying them on the same hierarchical level.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to hierarchically display, when a feature represented by three-dimensional model data and linked with product manufacturing information is assessed by an overall inspection result derived from multiple individual inspection results for the feature, the multiple individual inspection results, which indicate whether corresponding multiple measured values of the feature satisfy a preset allowable condition represented by the product manufacturing information, and the overall inspection result for the feature derived from the individual inspection results.

### BRIEF DESCRIPTION OF THE DRAWINGS

An exemplary embodiment of the present disclosure will be described in detail based on the following figures, wherein:

FIG. 1 illustrates an example of the system configuration of a drawing data processing system according to an exemplary embodiment of the disclosure;

FIG. 2 illustrates an example of three-dimensional (3D) model data appended with product manufacturing information;

FIG. 3 is a block diagram illustrating an example of the hardware configuration of a terminal apparatus in the exemplary embodiment;

FIG. 4 is a block diagram illustrating an example of the functional configuration of the terminal apparatus in the exemplary embodiment;

FIG. 5 illustrates that input measured values of multiple measurement portions are being stored in a data storage in the form of a hierarchical structure;

FIG. 6 illustrates an example of a display screen that presents a 3D model of a certain molded product and overall inspection results for multiple features included in the 3D model;

FIG. 7 illustrates an example of a display screen to be displayed when a user selects one of the features on the screen in FIG. 6;

FIG. 8 illustrates an example of a display screen to be displayed when individual inspection results for multiple regions of the feature selected on the screen in FIG. 7 are displayed; and

FIG. 9 illustrates another example of a hierarchical structure in which inspection results are displayed.

### DETAILED DESCRIPTION

An exemplary embodiment of the disclosure will be described below in detail with reference to the accompanying drawings.

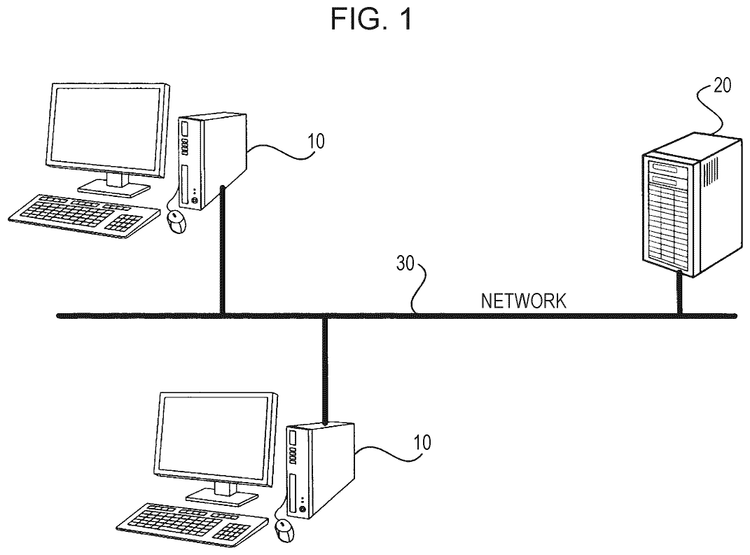

FIG. 1 illustrates an example of the system configuration of a drawing data processing system according to an exemplary embodiment of the disclosure.

As illustrated in FIG. 1, the drawing data processing system of the exemplary embodiment includes multiple terminal apparatuses 10 and a drawing data management server 20 connected to each other via a network 30. The drawing data management server 20 manages drawing data, such as parts drawings and product drawings, used for designing various products. Each of the terminal apparatuses 10 is an information processing apparatus that can download and display drawing data managed by the drawing data management server 20, perform various operations, such as correcting and modifying downloaded drawing data, and upload processed drawing data on the drawing data management server 20.

The drawing data managed by the drawing data management server 20 is three-dimensional (3D) model data appended with product manufacturing information (PMI) that includes, not only product shape information of the shape of a molded product, but also specification information on the dimensions of the molded product illustrated in drawings (hereinafter may also be simply called nominal sizes) and their tolerances.

These days, on 3D computer-aided design (CAD), specification information on the nominal sizes (also called nominal dimensions) and tolerances of a molded product, as well as product shape information of the shape of the molded product, is included in 3D model data as PMI. In accordance with this tendency, when a 3D model is displayed, PMI can also be displayed on the 3D model as 3D annotations, which makes it possible to understand required information, such as nominal sizes and tolerances and other information even without a two-dimensional drawing.

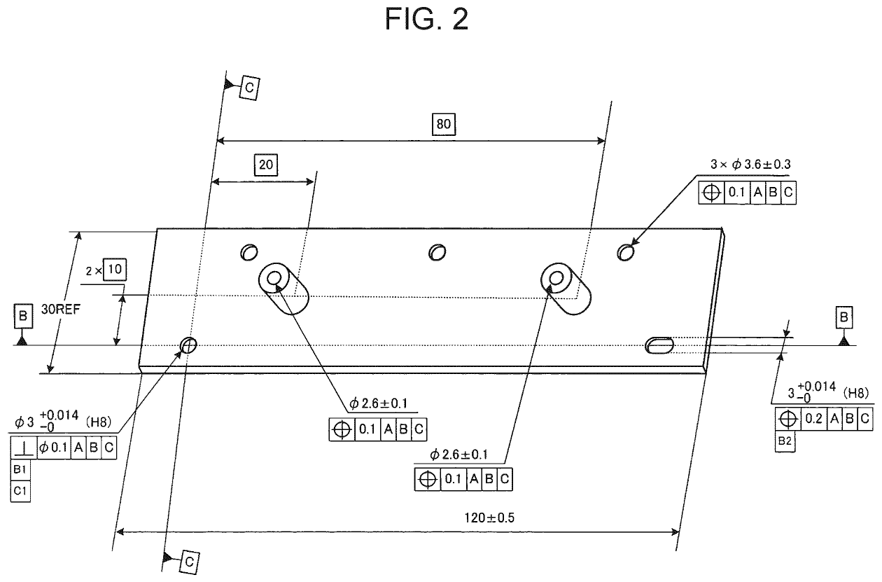

An example of such 3D model data appended with PMI is shown in FIG. 2. It is seen from FIG. 2 that various items of PMI, such as dimensional tolerances, geometric tolerances, theoretically exact dimensions (TED), are displayed on the 3D model as 3D annotations.

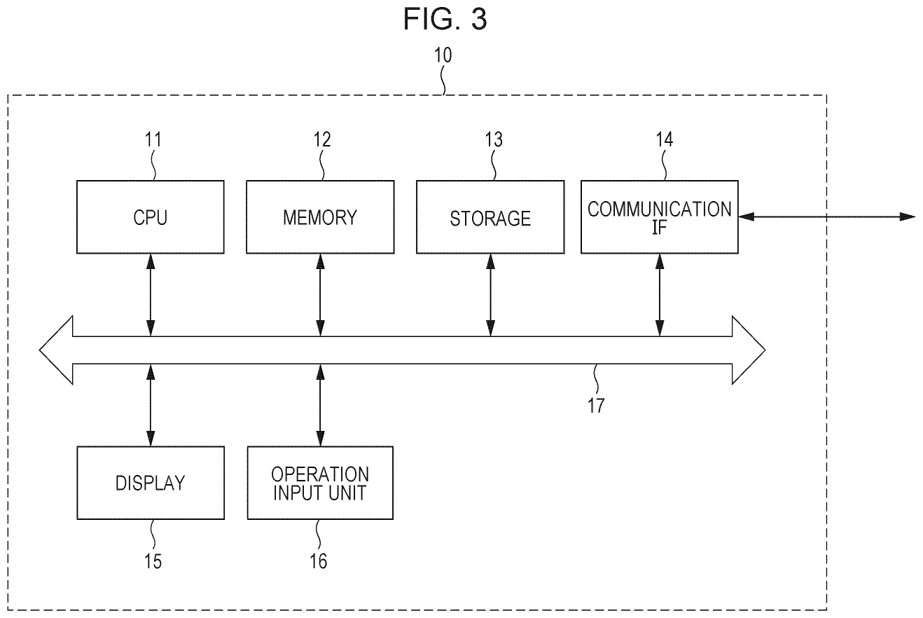

FIG. 3 is a block diagram illustrating an example of the hardware configuration of the terminal apparatus 10 in the drawing data processing system of the exemplary embodiment.

As illustrated in FIG. 3, the terminal apparatus 10 includes a central processing unit (CPU) 11, a memory 12, a storage 13, such as a hard disk drive, a communication interface (IF) 14 that transmits and receives data to and from external devices via the network 30, a display 15, such as a liquid crystal display, and an operation input unit 16 including a touch panel or a keyboard. These elements are connected to each other via a control bus 17.

The CPU 11 is a processor that executes predetermined processing based on a control program stored in the memory 12 or the storage 13 so as to control the operation of the terminal apparatus 10. In the exemplary embodiment, the CPU 11 reads the control program stored in the memory 12 or the storage 13 and executes it. However, the control program may be provided as a program product recorded on a computer readable medium. For example, the program may be provided in a form recorded on an optical disc, such as a compact disc-read only memory (CD-ROM) and a digital versatile disc (DVD)-ROM, or on a semiconductor memory, such as a universal serial bus (USB) memory and a memory card. The program may be obtained from an external device via a communication line connected to the communication IF 14.

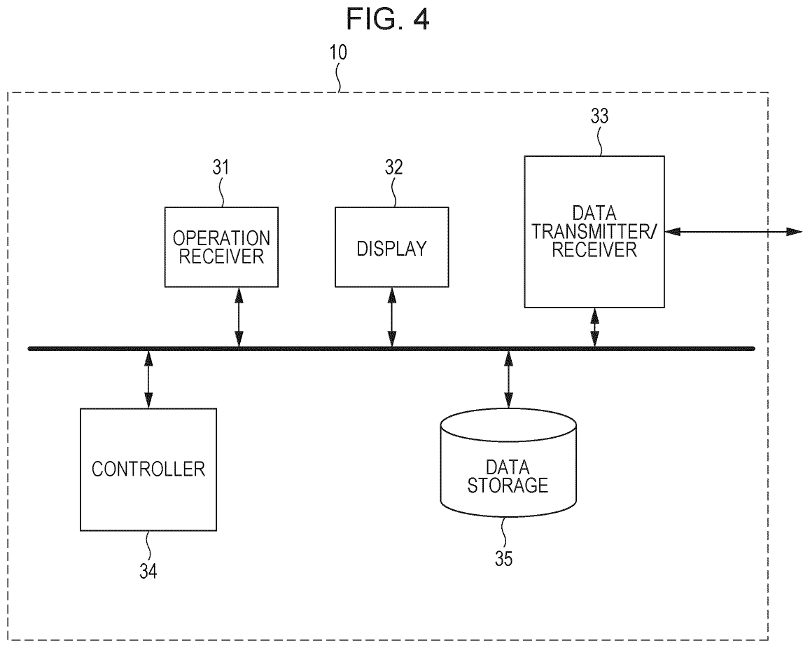

FIG. 4 is a block diagram illustrating an example of the functional configuration of the terminal apparatus 10 which is implemented as a result of the CPU 11 executing the above-described control program.

As illustrated in FIG. 4, in the exemplary embodiment, the terminal apparatus 10 includes an operation receiver 31, a display 32, a data transmitter/receiver 33, a controller 34, and a data storage 35.

The data transmitter/receiver 33 transmits and receives data to and from external devices, such as the drawing data management server 20.

The display 32 displays various pieces of information for a user under the control of the controller 34. The operation receiver 31 receives various operations performed by a user.

The controller 34 receives drawing data from the drawing data management server 20 via the data transmitter/receiver 33, stores the received drawing data in the data storage 35, and displays the drawing data stored in the data storage 35. The controller 34 also modifies drawing data stored in the data storage 35 based on a user operation received by the operation receiver 31 and uploads the modified drawing data on the drawing data management server 20 via the data transmitter/receiver 33.

In the exemplary embodiment, when an actual molded product is produced based on 3D model data appended with PMI, the controller 34 determines multiple features of the molded product to be parts to be inspected (hereinafter may also be called inspection target parts or target parts) and inputs inspection results for each of the inspected parts. To inspect a target part is to determine whether the result of measuring a feature of the molded product satisfies an allowable condition represented by PMI set for this feature. If all the features included in the molded product are determined to be a pass by their inspection results, the product is deemed to be a pass. If any of the features is determined to be a fail by the inspection result, certain corrective measures are taken for this rejected feature. For example, the molding conditions for the rejected feature are corrected, or a mold is adjusted.

As for the method for measuring the dimensions of the features included in the molded product, either of the following methods may be employed: an inspection probe is brought into direct contact with the inspection target parts of the product; or a certain measuring machine, such as a 3D coordinate measuring machine, is used to obtain 3D coordinates of the inspection target parts in a non-contact manner.

The controller 34 may receive measurement data obtained by measuring the features of the inspection target parts via the data transmitter/receiver 33 or receive measurement data input by a user using the operation receiver 31. The controller 34 may prestore the measurement data of the features of the inspection target parts and then obtain the measurement data and display inspection results.

There may be a case in which, not one measurement region, but multiple measurement regions are set for an inspection target part, such as when an inspection target part of the molded product formed based on the 3D model data is long and thin. In such a case, if an overall inspection result for the feature of an inspection target part is only displayed, a user is unable to identify the outcome of the inspection result of each of the measurement regions. That is, if a certain feature is determined to be a fail by the overall inspection result, it is not certain whether this feature has failed because the inspection results of most of the measurement regions indicate a fail or this feature has failed although the inspection results of only some of the measurement regions indicate a fail. Both of the individual inspection results and the overall inspection result may be displayed together, but if they are displayed on the same hierarchical level, the display content becomes complicated as the number of features of inspection target parts is increased.

To address this issue, in the exemplary embodiment, the controller 34 displays the inspection results for the features of multiple inspection target parts on the display 32 in the following manner.

When the feature of an inspection target part linked with PMI appended to 3D model data is assessed by the overall inspection result derived from the individual inspection results for this feature, the controller 34 first receives input of multiple measured values for the feature.

Then, the controller 34 hierarchically displays on the display 32 the individual inspection results, which each indicate whether the corresponding measured value satisfies a predetermined allowable condition represented by PMI, and the overall inspection result for the feature derived from the individual inspection results.

Multiple measured values for a certain feature mean the measured values of multiple regions of this feature and/or the measured values for this feature obtained under different conditions.

Multiple regions of a certain feature refer to multiple measurement portions linked with the same nominal size, such as the left side portion, the central portion, and the right side portion of this feature.

The measured values for a certain feature obtained under different conditions correspond to the measured value of a certain feature when the feature is constrained, such as when the feature is fixed, and the measured value when the feature is in a free state, such as when the feature is placed without being constrained. The measured values for a certain feature obtained under different conditions also correspond to the measured value of a certain feature when the feature is receiving an object and the measured value when the feature has received the object, such as, if the feature is a hole, the measured value when a probe is being inserted into the hole and the measured value when the probe has been inserted into the hole. The measured values for a certain feature obtained under different conditions also correspond to the measured value of a certain feature when the feature is in a maximum state and the measured value when the feature is in a minimum state, such as, if the feature is configured to vibrate, the measured value when the feature is vibrated to the maximum range and the measured value when the feature is vibrated to the minimum range.

In this manner, if multiple measured values are found for one feature, the measured values may be those obtained from multiple regions of the feature, and/or the measured values may be those obtained for the feature under different measurement conditions.

For simple description, however, a case in which multiple measured values are found for one feature will be explained below.

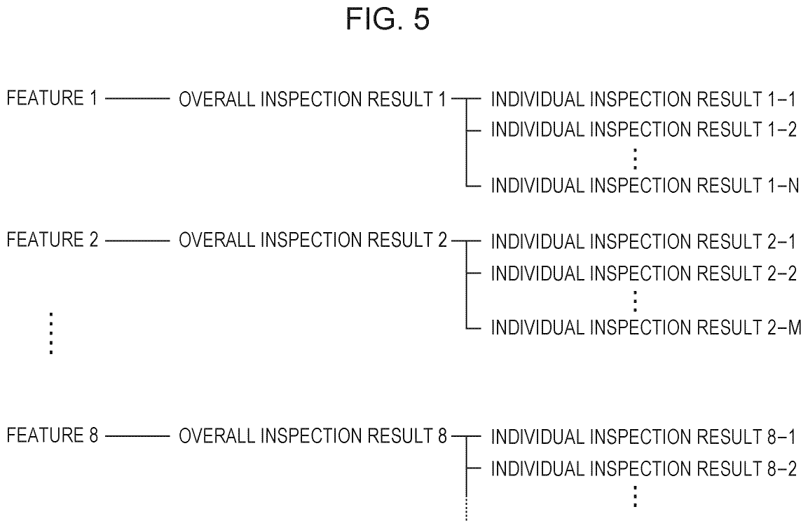

The controller 34 stores the input measured values of multiple measurement portions of the feature in the data storage 35 in the form of a hierarchical structure, such as that shown in FIG. 5. An example in which eight inspection target parts, namely, feature 1 through feature 8, are included in a 3D model is shown in FIG. 5. More specifically, overall inspection results 1 through 8 are registered for feature 1 through feature 8, respectively, and under the overall inspection results 1 through 8, individual inspection results 1-1 through 1-N through inspection results 8-1 . . . are registered. For a certain feature, only when the measurement portions of the feature are all determined to be a pass by the individual inspection results, the feature is deemed to be a pass by the overall inspection result. In other words, if even one of the individual inspection results indicates a fail, this feature is deemed to be a fail by the overall inspection result.

The allowable condition represented by PMI is a condition that, if a dimensional tolerance is indicated in PMI, the measured value is smaller than or equal to the upper limit of size and is larger than or equal to the lower limit of size. For example, if a nominal size is 100 mm and +1.0 mm and −0.5 mm are set as the tolerance, the upper limit of size is 101.0 mm and the lower limit of size is 99.5 mm. In this case, the difference in the acceptable values is +1.0 mm/−0.5 mm and the dimensional tolerance is a range of −0.5 to +1.0, that is, 1.5 mm.

If a geometric tolerance, such as a profile tolerance, is indicated by PMI, for example, if a profile tolerance of 1.0 mm is set for a certain surface, the allowable condition is a condition that the whole surface is contained within two envelope surfaces generated by a sphere having a diameter of 1.0 mm, the center of which is placed on a surface having a theoretically exact profile.

The allowable condition may be a condition that the measured value of surface texture (surface roughness), hardness, glossiness, or pullout force, for example, exceeds a threshold or does not exceed the threshold. The allowable condition may be a condition that the measured values conform to the standards defined by JIS (Japanese Industrial Standards) or ISO (International Organization for Standardization) or to the states defined by specifications or instructions.

The controller 34 may display a statistical value for the individual inspection results, together with the overall inspection result.

For example, the controller 34 may display, as a worst value, the measured value closest to the limit of the tolerance interval if all the measured values are within the tolerance interval, the measured value farthest from the limit of the tolerance interval if all the measured values are outside the tolerance interval, and the measured value outside the tolerance interval if the measured values include a measured value within the tolerance interval and a measured value outside the tolerance interval.

This will be explained more specifically. It is now assumed that the tolerance interval is defined by the dimensional tolerance and that the nominal size is 100 mm, the lower limit of size is 99.5 mm (100−0.5), and the upper limit of size is 101.0 mm (100+1.0). In this case, if the measured values are 99.6 mm (difference of 0.1) and 100.8 mm (difference of 0.2), the worst value is 99.6 mm although the two measured values are both within the tolerance interval.

If the measured values are 99.2 mm (difference of 0.3) and 100.8 mm (difference of 0.2), the worst value is 99.2 mm regardless of the magnitude of difference because 99.2 mm is lower than the tolerance interval. If multiple measured values are outside the tolerance interval, the measured value that is farther from the tolerance interval, namely, the measured value having a larger difference, is the worst value.

The controller 34 may display information whether the overall inspection result for a feature indicates a pass or a fail. The display 34 may also display, as a pass rate, the ratio of the features that are determined to be a pass by the overall inspection results to all the features included in 3D model data.

For example, if the number of features included in a 3D model is 80 and the number of features that are determined to be a pass by the overall inspection results is 72, the controller 34 displays on the display 32 that the pass rate is 90% (72/80×100).

In accordance with information on PMI of a feature extracted from 3D model data, the controller 34 may set regions to be measured for this feature and the number of such regions. In this case, the controller 34 receives input of the measured value of each of the set regions.

More specifically, the controller 34 sets regions to be measured and the number of regions by using at least one or more items of information selected from the type of PMI for a feature to be inspected, the shape, the material, and the color of the feature, the value of the nominal size, the required accuracy, and the processing method.

For example, the controller 34 sets regions to be measured and the number of regions in accordance with the length or the area of a feature to be inspected. More specifically, as the length of the feature is longer or as the area of the feature is larger, the controller 34 sets a greater number of regions to be inspected. The controller 34 also sets regions to be measured and the number of regions in accordance with the type of feature to be inspected, such as in accordance with whether the feature is a hole or a surface.

In short, the controller 34 increases the number of regions to be measured if a feature to be inspected is larger or longer. For example, if the shape of a feature is a plane or a cylindrical surface, the controller 34 changes the number of regions to be measured in the following manner in accordance with the reference value of the length of the plane or that of the arc length of the cylindrical surface.

If the reference value is 100 mm or smaller, the controller 34 sets one region to be measured.

If the reference value is greater than 100 mm and does not exceed 300 mm, the controller 34 sets two regions to be measured.

If the reference value is greater than 300 mm and does not exceed 500 mm, the controller 34 sets three regions to be measured.

If the reference value is greater than 500 mm, the controller 34 adds one more region for each 200 mm increment.

For example, if the nominal size set for a feature to be inspected is 540 mm, the controller 34 sets four regions to be measured.

When creating a sample (prototype) based on a 3D model, multiple samples may be created under various manufacturing conditions, such as different temperatures, at various times, or with the use of various molds. In such a case, the controller 34 receives input of the measured values of multiple samples for the same product created under different manufacturing conditions, at different times, or with the use of different molds. Then, the controller 34 hierarchically displays on the display 32 the overall inspection result indicating whether the measured values deviating from the nominal size are within a preset tolerance and also displays individual inspection results for the multiple regions in each of the samples produced under different manufacturing conditions, at different times, or with the use of different molds.

When one of the features of multiple inspection target parts is selected by a user, the controller 34 may display PMI set for the selected feature and multiple regions set for this feature so that the user can recognize them on 3D model data.

For example, the controller 34 displays PMI set for the selected feature and multiple regions set for this feature in a color different from those of other PMI and regions on 3D model data so that the user can recognize them on 3D model data.

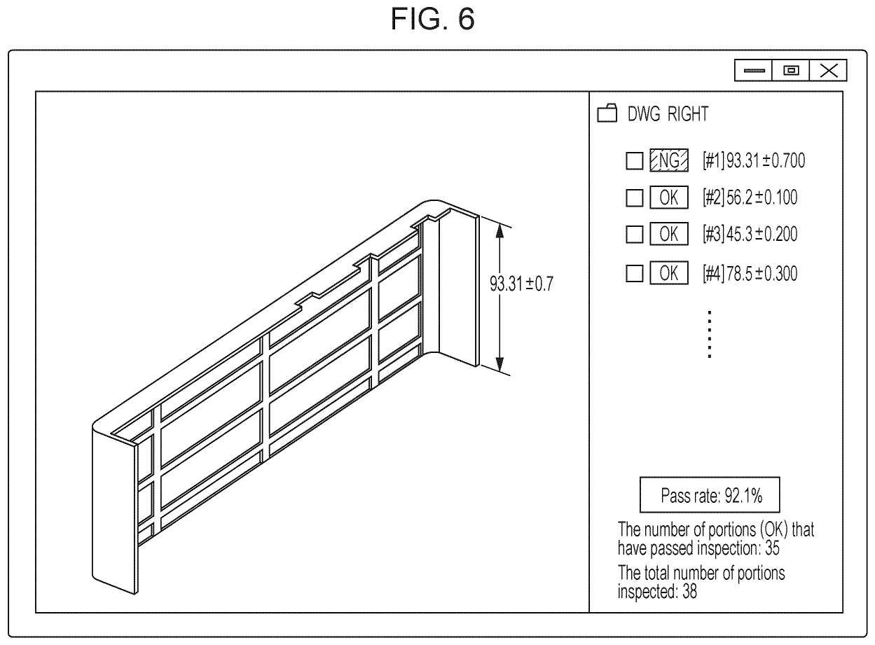

An explanation will now be given, with reference to FIGS. 6 through 8, of examples of display screens for displaying inspection results of individual target parts together with a 3D model in the terminal apparatus 10 of the exemplary embodiment.

An example of the display screen for a 3D model of a certain molded product and the overall inspection results for multiple features included in the 3D model displayed on the display 32 is shown in FIG. 6.

For easy understanding of the display content, only one dimension value is set for each feature as PMI in FIG. 6. In actuality, however, various types of PMI are displayed together with the 3D model.

In the example of the display screen in FIG. 6, the overall inspection result for each of inspection target parts, namely, feature 1, feature 2, feature 3, feature 4, . . . , is displayed as OK (pass) or NG (fail).

In the example of the display screen in FIG. 6, the total number of inspection target features included in the 3D model is 38, and the number of features that are determined to be a pass (OK) is 35, so that the pass rate is 92.1%.

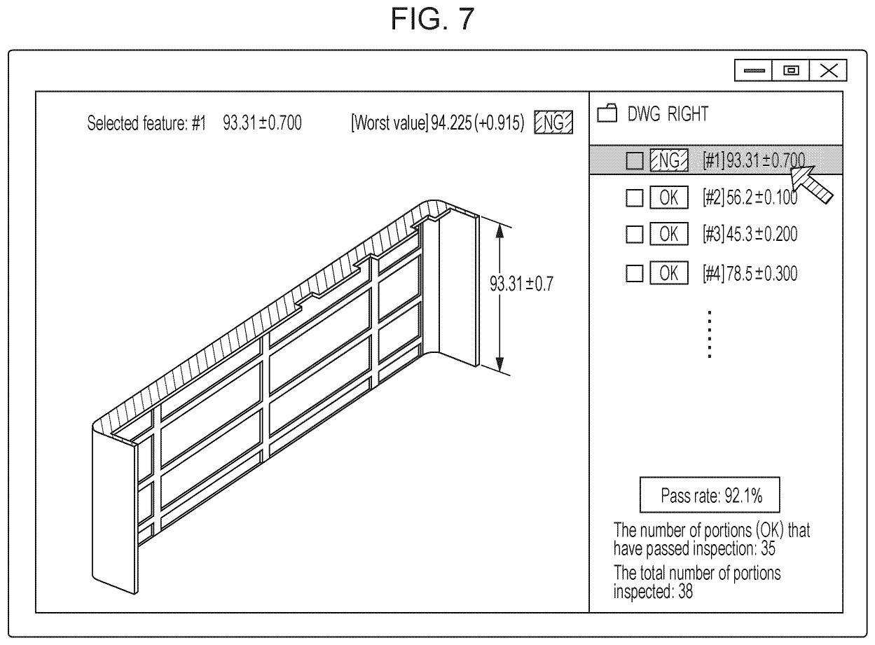

An example of the display screen to be displayed when a user selects feature 1 from among the features on the screen in FIG. 6 is shown in FIG. 7.

In FIG. 7, as a result of the user having selected feature 1, the position of feature 1 in the 3D model is displayed in a color different from those of the other positions. The screen in FIG. 7 is displayed so that the user can recognize that the selected feature is feature 1, the nominal size set for feature 1 is 93.31, and the dimensional tolerance for feature 1 is 93.31±0.700. FIG. 7 also shows that, among the measured values of multiple portions of feature 1, the measured value having the largest difference from the nominal size is displayed as the worst value. Specifically, the numeral value “94.225(+0.915)” is selected as the worst value.

Displaying the worst value makes it possible to identify that the measured value having the largest difference from the nominal size is 94.225 mm and the difference is +0.915 mm.

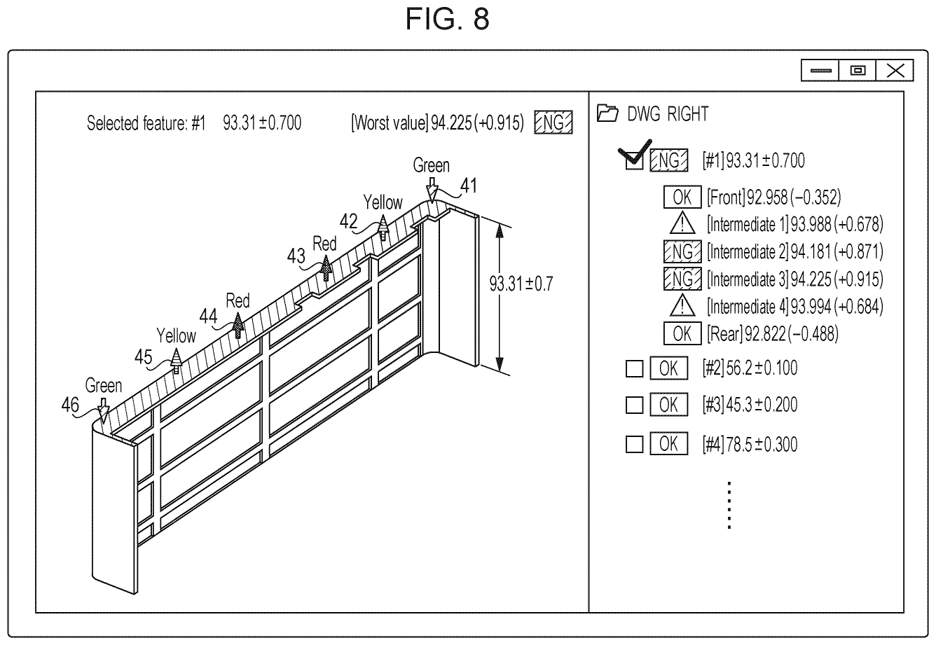

An example of the screen to be displayed when individual inspection results for multiple regions of feature 1 selected on the screen in FIG. 7 are displayed is shown in FIG. 8.

FIG. 8 shows that six regions, that is, a front portion, intermediate portions 1 through 4, and a rear portion, are set for feature 1. In the example of the display screen in FIG. 8, six arrow objects 41 through 46 are displayed on the selected feature 1 so that the user can recognize the positions of the six regions.

The six arrow objects 41 through 46 are displayed in different colors and the difference in the colors enables the user to understand how much the measured values of these regions deviate from the nominal size.

For example, the relationship between each of the measured values and the tolerance range defined by the upper tolerance and the lower tolerance is indicated by the color set for the corresponding arrow object. An example of the classification by color is as follows.
Red: the measured value exceeds the upper tolerance.
Yellow: the measured value is approaching the upper tolerance.
Green: the measured value is within the tolerance range.
Light blue: the measured value is approaching the lower tolerance.
Blue: the measured value is lower than the lower tolerance.

The direction of the arrow objects 41 through 46, namely, whether each of the arrow objects 41 through 46 faces upward or downward, indicates whether the measured value of the corresponding portion is larger or smaller than the nominal size. When the arrow object faces upward, the measured value is larger than the nominal size. When the arrow object faces downward, the measured value is smaller than the nominal size.

For example, among the six regions of feature 1, the measured value of the front portion is 92.958 and is lower than the nominal size, namely, 93.31, by 0.352. However, this measured value is around the center of the dimensional tolerance, namely, ±0.700. In FIG. 8, the arrow object 41 represents the measurement position of the front portion, the direction of the arrow object 41 facing downward indicates that the measured value is lower than the nominal size, and the color (green) of the arrow object 41 indicates that the measured value is around the center of the tolerance range.

The arrow objects 42 and 45 represent the measurement positions of the intermediate portions 1 and 4, the direction of the arrow objects 42 and 45 facing upward indicates that the measured values exceed the nominal size, and the color (yellow) of the arrow objects 42 and 45 indicates that the measured values are approaching the upper tolerance.

Likewise, the arrow objects 43 and 44 represent the measurement positions of the intermediate portions 2 and 3, the direction of the arrow objects 43 and 44 facing upward indicates that the measured values exceed the nominal size, and the color (red) of the arrow objects 43 and 44 indicate that the measured values exceed the upper tolerance.

Symbols, such as OK and NG, appended to the measured values of the measurement portions, namely, the front portion, intermediate portions 1 through 4, and rear portion, indicate the individual inspection results of the measurement portions.

In the above-described example, the overall inspection result of a certain inspection target part and individual inspection results of multiple measurement portions set for this part are displayed hierarchically. However, the hierarchical structure of inspection results may be expressed in a more complicated manner.

For example, when a prototype of a molded product is created based on a 3D model, multiple samples may be created under various manufacturing conditions, such as different temperatures, at various times, or with the use of various molds. In such a case, the measured values of the samples created under different manufacturing conditions, at different times, or with the use of different molds are obtained for each of the measurement portions of one inspection target part.

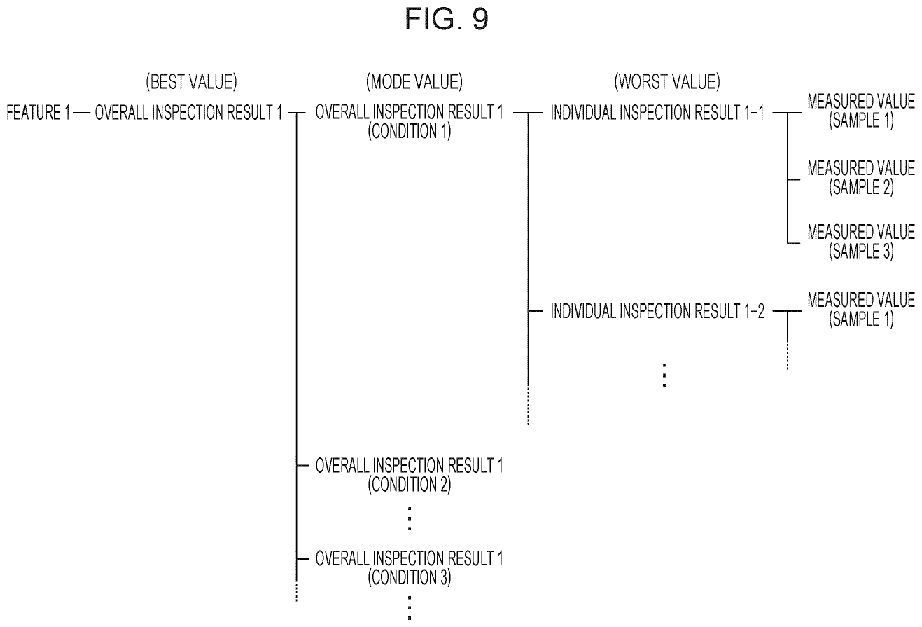

An example of the hierarchical structure used for hierarchically displaying the inspection results in such a case is shown in FIG. 9.

In the example in FIG. 9, for even one inspection target part, such as feature 1, multiple overall inspection results obtained under different manufacturing conditions or another factor are provided. Then, for each of the overall inspection results, individual inspection results of different measurement portions are provided. Then, for each of the individual inspection results, multiple measurement values of individual samples created at different times or with the use of different molds are provided.

With the use of such a hierarchical structure, when an individual inspection result is displayed, for example, the worst value among multiple measured values of different samples may also be displayed. When multiple overall inspection results are displayed, the mode value among the individual inspection results may also be displayed.

Additionally, when one overall inspection result of a certain feature, such as feature 1, is displayed, the best value among the overall inspection results obtained under different manufacturing conditions or another factor may also be displayed. Displaying the best value among the overall inspection results makes it possible to identify how much the actual molded product can approach the nominal size as a result of varying the manufacturing conditions and finding the optimal condition.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

“System” in the exemplary embodiment encompasses both of a system constituted by a single apparatus and a system constituted by multiple apparatuses.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

Exemplary embodiments of the disclosure will be described below.
(((1)))
   An information processing system comprising:
   A Processor Configured to:
      hierarchically display, when a feature represented by three-dimensional model data and linked with product manufacturing information is assessed by an overall inspection result derived from a plurality of individual inspection results for the feature, the plurality of individual inspection results, which indicate whether a plurality of corresponding measured values of the feature satisfy a preset allowable condition represented by the product manufacturing information, and the overall inspection result for the feature derived from the individual inspection results.
(((2)))
   The information processing system according to (((1))), wherein the plurality of measured values are measured values for a plurality of regions of the feature.
(((3)))
   The information processing system according to (((1))), wherein the plurality of measured values are measured values for the feature obtained under a plurality of conditions.
(((4)))
   The information processing system according to one of (((1))) to (((3))), wherein the processor is configured to display a statistical value for the individual inspection results, together with the overall inspection result.
(((5)))
   The information processing system according to (((4))), wherein the processor is configured to display, as a worst value, a measured value which is closest to a limit of a tolerance interval when the measured values are all within the tolerance interval, a measured value which is farthest from the limit of the tolerance interval when the measured values are all outside the tolerance interval, or a measured value outside the tolerance interval when the measured values include a measured value within the tolerance interval and a measured value outside the tolerance interval.
(((6)))
   The information processing system according to one of (((1))) to (((5))), wherein the processor is configured to:
      display whether the feature is determined to be a pass or a fail by the overall inspection result; and
      display, as a pass rate, a ratio of features which are determined to be a pass by overall inspection results to a plurality of features included in the three-dimensional model data.
(((7)))
   The information processing system according to (((2))), wherein the processor is configured to set regions to be measured for the feature and the number of regions to be measured in accordance with information on the product manufacturing information of the feature extracted from the three-dimensional model data.
(((8)))
   The information processing system according to (((7))), wherein the processor is configured to set the regions to be measured and the number of regions to be measured, by using at least one or more items of information selected from the type of product manufacturing information for the feature to be inspected, a shape, a material, and a color of the feature, a value of a nominal size, required accuracy, and a processing method.
(((9)))
   The information processing system according to one of (((1))) to (((8))), wherein the plurality of individual inspection results to be hierarchically displayed are individual inspection results indicating whether measured values of a plurality of samples created for an identical product under different manufacturing conditions, at different times, or with use of different molds satisfy the preset allowable condition represented by the product manufacturing information, and the overall inspection result to be hierarchically displayed is an overall inspection result derived from the plurality of individual inspection results indicating whether the measured values of the plurality of samples satisfy the preset allowable condition.
(((10)))
   The information processing system according to (((2))), wherein the processor is configured to display, when one of a plurality of features included in the three-dimensional model data is selected, product manufacturing information set for the selected feature and a plurality of regions set for the selected feature so that a user is able to recognize the product manufacturing information and the plurality of regions on the three-dimensional model data.
(((11)))
   A program causing a computer to execute a process, the process comprising:
      obtaining, when a feature represented by three-dimensional model data and linked with product manufacturing information is assessed by an overall inspection result derived from a plurality of individual inspection results for the feature, a plurality of measured values of the feature; and
      hierarchically displaying the plurality of individual inspection results, which indicate whether the plurality of corresponding measured values satisfy a preset allowable condition represented by the product manufacturing information, and the overall inspection result for the feature derived from the individual inspection results.

What is claimed is:

1. An information processing system comprising:
a processor configured to:
hierarchically display, when a feature represented by three-dimensional model data and linked with product manufacturing information is assessed by an overall inspection result derived from a plurality of individual inspection results for the feature, the plurality of individual inspection results, which indicate whether a plurality of corresponding measured values of the feature satisfy a preset allowable condition represented by the product manufacturing information, and the overall inspection result for the feature derived from the individual inspection results.

2. The information processing system according to claim 1, wherein the plurality of measured values are measured values for a plurality of regions of the feature.

3. The information processing system according to claim 1, wherein the plurality of measured values are measured values for the feature obtained under a plurality of conditions.

4. The information processing system according to claim 1, wherein the processor is configured to display a statistical value for the individual inspection results, together with the overall inspection result.

5. The information processing system according to claim 2, wherein the processor is configured to display a statistical value for the individual inspection results, together with the overall inspection result.

6. The information processing system according to claim 3, wherein the processor is configured to display a statistical value for the individual inspection results, together with the overall inspection result.

7. The information processing system according to claim 4, wherein the processor is configured to display, as a worst value, a measured value which is closest to a limit of a tolerance interval when the measured values are all within the tolerance interval, a measured value which is farthest from the limit of the tolerance interval when the measured values are all outside the tolerance interval, or a measured value outside the tolerance interval when the measured values include a measured value within the tolerance interval and a measured value outside the tolerance interval.

8. The information processing system according to claim 5, wherein the processor is configured to display, as a worst value, a measured value which is closest to a limit of a tolerance interval when the measured values are all within the tolerance interval, a measured value which is farthest from the limit of the tolerance interval when the measured values are all outside the tolerance interval, or a measured value outside the tolerance interval when the measured values include a measured value within the tolerance interval and a measured value outside the tolerance interval.

9. The information processing system according to claim 6, wherein the processor is configured to display, as a worst value, a measured value which is closest to a limit of a tolerance interval when the measured values are all within the tolerance interval, a measured value which is farthest from the limit of the tolerance interval when the measured values are all outside the tolerance interval, or a measured value outside the tolerance interval when the measured values include a measured value within the tolerance interval and a measured value outside the tolerance interval.

10. The information processing system according to claim 1, wherein the processor is configured to:
display whether the feature is determined to be a pass or a fail by the overall inspection result; and
display, as a pass rate, a ratio of features which are determined to be a pass by overall inspection results to a plurality of features included in the three-dimensional model data.

11. The information processing system according to claim 2, wherein the processor is configured to:
display whether the feature is determined to be a pass or a fail by the overall inspection result; and
display, as a pass rate, a ratio of features which are determined to be a pass by overall inspection results to a plurality of features included in the three-dimensional model data.

12. The information processing system according to claim 3, wherein the processor is configured to:
display whether the feature is determined to be a pass or a fail by the overall inspection result; and
display, as a pass rate, a ratio of features which are determined to be a pass by overall inspection results to a plurality of features included in the three-dimensional model data.

13. The information processing system according to claim 4, wherein the processor is configured to:
display whether the feature is determined to be a pass or a fail by the overall inspection result; and
display, as a pass rate, a ratio of features which are determined to be a pass by overall inspection results to a plurality of features included in the three-dimensional model data.

14. The information processing system according to claim 5, wherein the processor is configured to:
display whether the feature is determined to be a pass or a fail by the overall inspection result; and
display, as a pass rate, a ratio of features which are determined to be a pass by overall inspection results to a plurality of features included in the three-dimensional model data.

15. The information processing system according to claim 6, wherein the processor is configured to:
display whether the feature is determined to be a pass or a fail by the overall inspection result; and
display, as a pass rate, a ratio of features which are determined to be a pass by overall inspection results to a plurality of features included in the three-dimensional model data.

16. The information processing system according to claim 2, wherein the processor is configured to set regions to be measured for the feature and the number of regions to be measured in accordance with information on the product manufacturing information of the feature extracted from the three-dimensional model data.

17. The information processing system according to claim 16, wherein the processor is configured to set the regions to be measured and the number of regions to be measured, by using at least one or more items of information selected from the type of product manufacturing information for the feature to be inspected, a shape, a material, and a color of the feature, a value of a nominal size, required accuracy, and a processing method.

18. The information processing system according to claim 1, wherein the plurality of individual inspection results to be hierarchically displayed are individual inspection results indicating whether measured values of a plurality of samples created for an identical product under different manufacturing conditions, at different times, or with use of different molds satisfy the preset allowable condition represented by the product manufacturing information, and the overall inspection result to be hierarchically displayed is an overall inspection result derived from the plurality of individual inspection results indicating whether the measured values of the plurality of samples satisfy the preset allowable condition.

19. The information processing system according to claim 2, wherein the processor is configured to display, when one of a plurality of features included in the three-dimensional model data is selected, product manufacturing information set for the selected feature and a plurality of regions set for the selected feature so that a user is able to recognize the product manufacturing information and the plurality of regions on the three-dimensional model data.

20. A non-transitory computer readable medium storing a program causing a computer to execute a process, the process comprising:
obtaining, when a feature represented by three-dimensional model data and linked with product manufacturing information is assessed by an overall inspection result derived from a plurality of individual inspection results for the feature, a plurality of measured values of the feature; and
hierarchically displaying the plurality of individual inspection results, which indicate whether the plurality of corresponding measured values satisfy a preset allowable condition represented by the product manufacturing information, and the overall inspection result for the feature derived from the individual inspection results.
